(19) United States
(12) Patent Application Publication
(10) Pub. No.: US 2010/0251141 A1
(43) Pub. Date: Sep. 30, 2010

(54) Method of Sharing Information Associated with a Webpage

(76) Inventors: Jason Allen Sabin, Lehi, UT (US); Richard Jeremy Rowley, Pleasant Grove, UT (US)

Correspondence Address: Richard Rowley, 1275 Fort Lane, Pleasant Grove, UT, 84062, US

(21) Appl. No.: 12/726,320

(22) Filed: Mar. 17, 2010

Related U.S. Application Data
(60) Provisional application No. 61/163,072, filed on Mar. 25, 2009.

(51) Int. Cl. G06F 15/16; G06F 3/048; G06F 17/30

(52) U.S. Cl. 715/758; 715/760; 707/812; 709/205; 707/E17.005; 707/E17.009

(57) ABSTRACT

The invention discloses a method of sharing webpages between users. Webpages are shared by uploading information to a database as users browse the web. The information is then disseminated to other users visiting the webpage. The invention also discloses customized method of displaying information related to the webpage, including by methods of displaying comments by user and on set locations of the webpage. The invention also includes a method of finding new friends with similar interests, and a method of finding new friends based on the similarity of interests between users.

### CROSS-REFERENCE TO RELATED APPLICATION

This application claims the benefit of provisional application Ser. No. 61/163,072 filed on Mar. 25, 2009 and which is incorporated herein by reference.

### BACKGROUND

The Internet has become so large that often new and interesting webpages can become lost and difficult to find. Users looking for new sites must filter through massive amounts of websites to find new content. For large companies, this increases the amount they must spend in advertising and promoting their site in order to achieve internet recognition. The effect on smaller companies is even more severe. Many of them fail to ever find their target audience and are lost among millions of other websites.

In addition, social networking sites are now extremely popular. On social networking sites, users can set up profiles, exchange messages, and even play games. This lets users stay connected regardless of where they are located. These systems function by allowing users to establish a list of contacts that then know and then communicating with those contacts.

Other sites attempt to solve the problem by allowing users to share websites with friends. These sites have users submit websites to a central server. Users can then rate the site, allowing top rated sites to become easily accessible to all users. These sites present the submitted websites as a list of popular sites, usually arranged in order of website popularity. However, this method shares websites with everyone and does not limit the sharing only to friends or people with similar interests.

Sharing is also not automatic through these sites and is only done when users visits the site. This often leads to users forgetting to share discovered websites.

Browsers already recognize the need to make websites easier to find. Some browsers have already introduced a concept of showing the most visited websites. However, the browsers only show the websites most frequented by the computer user. This limits the user's visits to websites they already know about and does not help the user find new websites.

### SUMMARY OF THE INVENTION

The current invention is an improvement on social networking that makes sharing website and finding new friends easy and convenient. The invention works by having a user browse various webpages. As the user browses webpages, information is sent to a database where it is stored. The stored information is then distributed to other users, allowing them to see website ratings and reviews.

The invention uses web services to provide real time and updated information to users without forcing the user to go to leave the webpage they are currently viewing.

The invention also discloses a method of displaying information to help users find new websites. Users can share web browsing experience or receive evaluated recommendations.

Users can use the data to meet new friends and see comments of friends and distant users. The display of the information allows users to see a web of friends and quickly change between friend views. The display can also be used to add comments and ratings to specific areas of the website rather than the website as a whole

### DESCRIPTION OF THE DRAWINGS

FIG. 1 is a depiction of the components of the invention.

FIG. 2 is a flow chart of how information is shared with other users.

FIG. 3 is a flow chart of how information can be shared between friends.

FIG. 4 is a depiction of how friend's share websites

FIG. 5 is a depiction of how shared webpage information can be displayed.

FIG. 6 is a depiction of how a user receives notification of certain actions.

FIG. 7 is a shared web session.

FIG. 8 is a flowchart of how webpages can be recommended.

FIG. 9 is a flowchart of how friends are recommended.

FIG. 10 is a depiction of how user comments can be displayed.

FIG. 11 is flowchart of how user comments and friends can be displayed.

FIG. 12 is a depiction of how the display can work on a smart phone using sliding functionality.

FIG. 13 is a depiction of how comments can be set to specific locations on the webpage.

### DETAILED DESCRIPTION

A plugin, as used herein, can refer to an applet, code running on a server, or an application running on a user's computer. A plugin could include a web browser designed to perform the invention, a separate application, or CGI code that runs on a server. The plugin also includes a remote webservice that performs the functions described herein. Plugin and webservice are used interchangeably herein. Webpage and website are also used interchangeably herein.

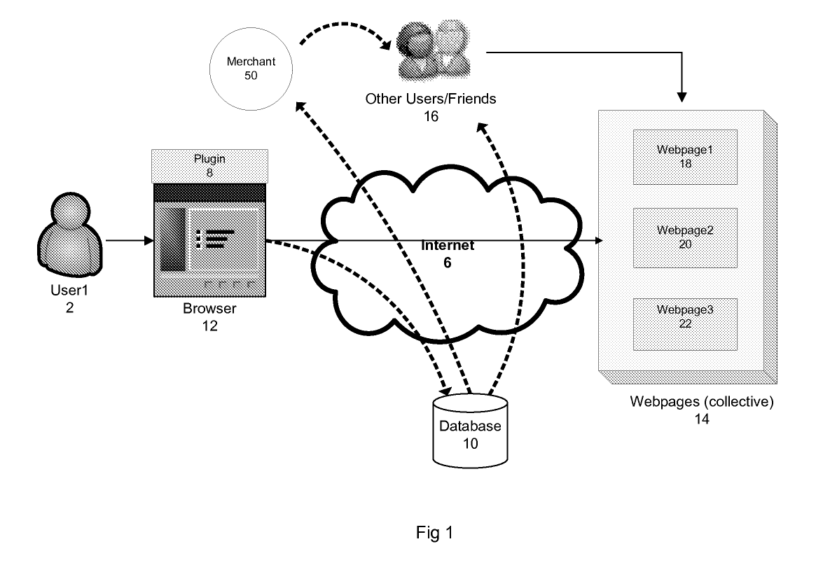

In the first embodiment, shown in FIG. 1 and FIG. 1, a user 2 accesses webpages 14 over the Internet 6 using a browser 12. In step 102, while showing sites, a plugin 8 monitors the user's Internet access and stores the domain names visited in a database 10. The domain names (or identifier) can be a primary domain, the fully qualified domain name, the full URL path, the full URL path with parameters, or any combination of these. Identifiers do not need to be an actual path to a webpage and can be a title of the website or some other identifying information about a visited webpage.

In step 104, the plugin stores the domain names on either a local database or on a server database (a remote database). If the domain names are stored in a local database, then the plugin should periodically connect to a server to upload information. A connection to a remote database can occur each time a webpage is visited or by establishing a continuous connection to the server for the duration of the browser session.

To make sharing quicker and more automated, the plugin can optionally upload the domain name information every time a webpage is visited unless the user has turned off an automatic upload setting. The setting can be toggle button or menu item on the plugin. By turning off the automatic upload setting, the user prevents webages from being uploaded to the server and shared with other users.

In addition to the domain name information, the plugin can also collect information about the user's opinion on the website. Opinion information includes user ratings, comments, notes, and sharing information. Ratings can take any form, such as a thumbs up/thumbs down, a star rating, a number rating, an alphabet grade, or any other rating system.

The information is uploaded to the database using HTTP or HTTPS. The data can be transmitted in any format, such as an XMLHTTPRequest object.

The database can also store information about the number of times the site has been visited. A site with lots of visits is a popular site. This can be done by storing the site each time it is visited or by incrementing a counter in the database of the number of visits.

When uploaded, the information is associated with the user's credential information, such as the user's name, email address, account number, or online handle. General information about the visited domain name, such as the date and time that the domain name was visited and the length of the visit, can also be stored.

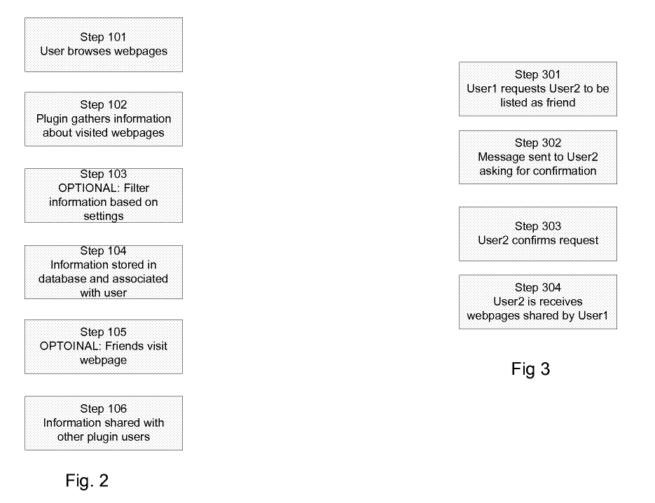

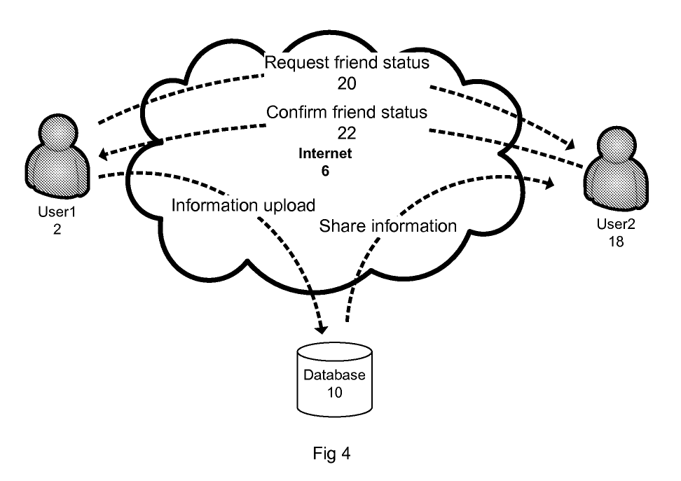

Optionally, in step 103 of FIG. 2, the information transmitted to the server can be filtered to ensure that only the appropriate information is uploaded. For example, in one embodiment the plugin only uploads information when granted express permission to do so by the user. A user grants express permission by clicking a button or user selecting a menu item of the plugin the initiates the upload of domain information to the database.

The plugin can also filter the data by type. In this embodiment, the plugin or server will check the information to ensure that it does not contain any objectionable material. The definition of objectionable material is based on criteria set by either the user or the database operator before the data is stored in the database. Filtering is done by having the user select which type of content should not be uploaded by the plugin. The filter will then check the meta-tags or content of the webpage to determine if the information should be stored. If the meta-tags or webpage content contains one of the filtered words or relate to a filtered world, then the information is not stored. The plugin can be set to only upload information if the webpage content matches the filter to further restrict uploading.

Instead of filtering the information at the plugin level, the server can check the information sent to it before storing the information in the database. Filters might check the meta-tags or webpage content for profanity, pornography, hate messages, political disputes, illegal material, gambling, etc. The filter can also operate by checking user comments added to the webpage for the restrictive words.

In step 105, once a database 10 of information exists, the information can then be shared with other users 16. Information is shared when another user 16 sends a request to retrieve database information. This request can be sent automatically each time a webpage is loaded by the other user's browser or by a plugin on the other user's computer.

The information retrieved from the database depends on the request. Typical requests are the most recently visited webpages, the most popular webpages, or demographic information about which webpages are visited by other users or a single user in particular, the location of the user, comments made by users about a webpage, and rating information. The ratings can be presented as rating made by each separate user or as an aggregate sum of all of the users. Users can filter the information retrieved to view who rated sites highly, to only return users with certain ratings, to only return users who left comments, to only display ratings from users who have visited the webpage more than a certain number of times, to only display ratings of new visitors, to display webpage visit information, etc.

In a separate embodiment, the returned information is filtered to include only friend information. A friend can be any person or entity associated with a user in the database. Friend information can be set by one user 2 specifying a second user 18 as a friend and then the second user confirming the relationship 22. Friend status can also be set by retrieving a list of contacts from an email application and setting each contact as a friend, a user unilaterally setting the friend information, retrieving friend information from social networking sites, or any combination of theses. Friend information does not need to be mutual, and one user can set themselves to follow another user. This allows a friend to see and follow another user's actions without actually being friend. Setting a user as a follower gives that user access to the database information submitted by followed user but does not actively identify the user as a friend. Commercial entities can share information using the database, including links to sales or links to partner URLs. Individuals can follow the commercial entity so that they can be aware of major sales and promotions.

Data filtered by friends can be displayed the same way as all other information. For example, the plugin can list the most recently visited websites, the most popular websites, rating information, comments, demographic information such as location information and webpage visit information, or any other information stored in the database both by friend and by the entire set of users.

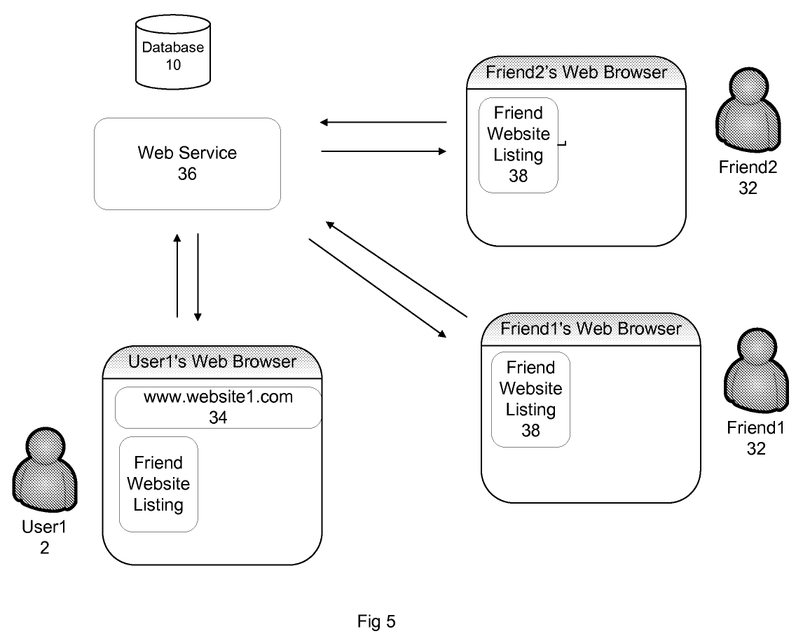

As shown in FIG. 5, in order to see friend information, a user 2 logs into the server via the plugin 36. The plugin uses the user credentials to retrieve information stored in the database 10 by friends 32. This information is then displayed 38 to the user 2 in any typical manner, such as through a chart, a list of information, or a graph. For example, the plugin can display information about which webpages receive the most views and also display a list of friends visiting the webpage. Next to each friend, the number of times they have visited the site. As a second example, the plugin can display a list of frequently visited websites along with information about which friends are visiting the website at that very moment.

The information can even display which webpage the friend is currently visiting. This works extremely well with forums as it allows users to see if their friends are chatting on a forum prior to visiting the forum itself. Which webpage is being visited can be displayed by taking the user to the webpage, displaying a popup image of the webpage, sending the user an alert about the webpage, displaying the URL of the webpage, displaying a representation of the friend and then adding a notice about the webpage to the representation, or in any other fashion.

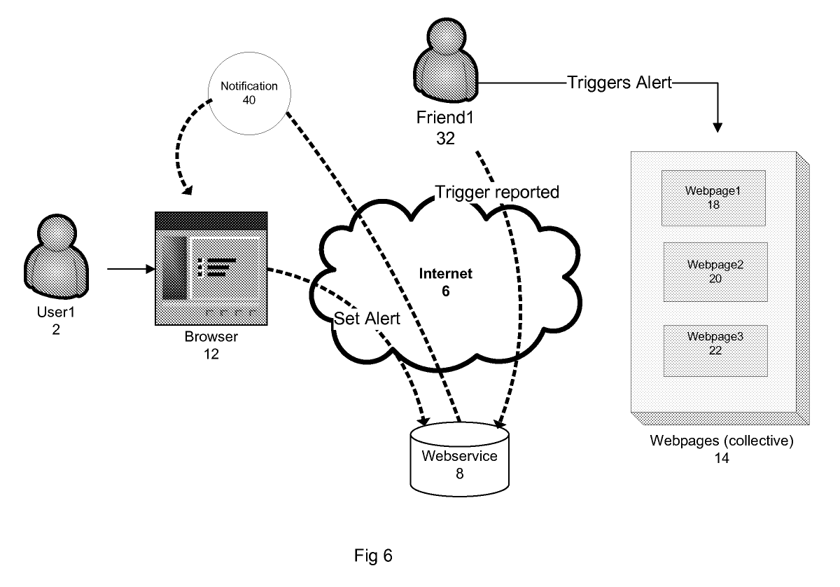

As shown in FIG. 6, the plugin 8 can also be configured to send a notification 40 to a user 2 if a friend 32 visits a certain webpage 18 or visits a webpage with a keyword. The notification can be an email notification, a flashing border or text, a pop up window, or any other common method of alerting a user about new data in the database 10. This allows the user to share their friend's experience with new webpages, without having to user an email account. The plugin 8 can be configured to send notification about any database information uploaded by a friend. For example, User1 2 can select to received notices 40 if friend1 18 does any of the following: visits a specific website (as selected by user1), visits a website with specific content or that has a specific meta-tag, rates a website, adds a comment to a website, visits a certain website more than a set number of times, or any other action that is stored by the database. This can be used as a monitoring tool for parents or significant others.

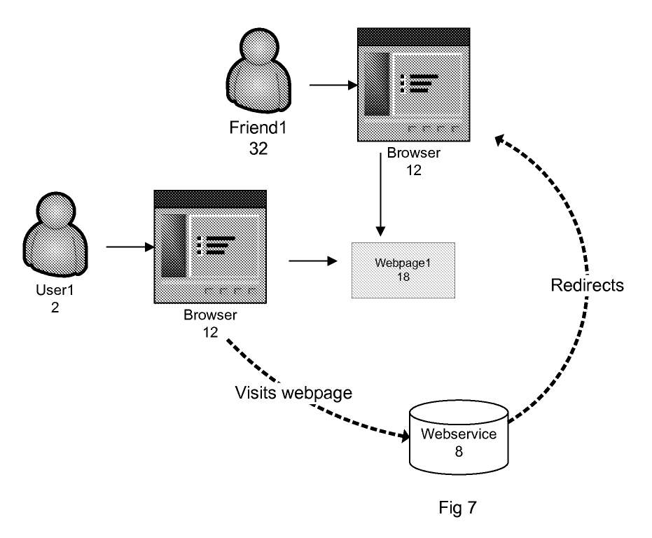

In FIG. 7, the plugin 8 can be configured to automatically take a friend 32 to the webpages being visited by its friends. In this embodiment, every time the user 2 visits or shares a webpage 18, all of the friends 32 connected to the user 2 are redirected to the same webpage 18. If the plugin contains a chat client, then the friends can talk about the webpage and share their thoughts. This allows a single user to do the browsing for one or more friends. This is extremely useful for online meetings, where a user might want to take his clients to other webpages to show them content.

The information returned from the database can be displayed in a variety of formats, including as a list on a webpage, on a sidebar of the webpage, or in a menu incorporated as part of the plugin. If the information is displayed in the aggregate, the user can get a break down of the data by clicking the information. For example, if the information displays the most popular websites, the user can click a website listing to see which friends have visited the website.

Other modes of viewing include: showing a list of friends along with their most visited website, a list of friends along with the most highly rated websites, a list of websites most frequently visited by friends, a list of sites most frequented by friends during that time of day, and a list of websites along with comments friends have made about the websites, or any combination of the above.

A user can click on a friend to see the friend's profile, including the webpages visited by the friend, rating information, popularity information, visit information, and comments. The websites can be listed from the most visited to the lease visited for easier viewing. The user can then visit the websites visited by their friends by clicking the link shown in the profile. The information can be showed to the user upon request or automatically when a webpage is visited. The plugin should periodically check the server to update the displayed information with any new information that has been recently added. For example, if a user visits a website the plugin will retrieve information about what other friends have done on the website. This can include the sub-pages visited, the time various friends visited the webpage, comments about the webpage (or certain parts of the webpage), various friends' ratings of the website, and other information. The plugin can be configured to retrieve this information as soon as the URL for the website is entered or can retrieve this information upon request by the user.

The plugin also contains a “surfing mode” to let users find new websites. Surfing mode will automatically present the user with new webpages retrieved from the database. These can be random webpages or webpages that the plugin things the user might like based on the previous webbpages viewed or rated by the user. A new webpage can be presented every time the user clicks a button or after a set amount of time has elapsed. Surfing mode can be turned on with a mouse over on toolbar, a button in the toolbar, or by having the second user simply visit the website.

The information stored in the database is valuable to merchants 50 as it helps merchants perform targeted marketing, receive customer feedback, and engage in viral marketing. Merchants can purchase the information or can subscribe to receive the information on a periodic interval. The plugin provider can also sell advertising links, allowing the merchant to pay to have the merchant's website displayed on the list of frequently visited websites.

Merchants can obtain information about the specific individuals who have visited the merchant's website, such as what other websites the individual is interested in, or general information about the type of websites their visitors are interested in. General information can be prepared by taking a collection of users who have rated the website and determining websites they have rated similar to the merchant's website. Merchants can pay to have their information displayed in a distinct manner or to include their logo next to their website link.

The plugin can be used to help user's find new webpages. The user logs into the database and retrieves a list of the most frequented or most popular websites. This can be arranged by friends or by every user of the plugin. The user then visits the webpage by clicking a link provided through the plugin.

Alternatively, the plugin can redirect the user's browser to a webpage that has a similar rating to the ones the user has highly rated. The plugin evaluates the webpages the user has rated and then searches the database for a website that other user's have rated well that the user has not rated. This can be limited to webpages that friends have rated.

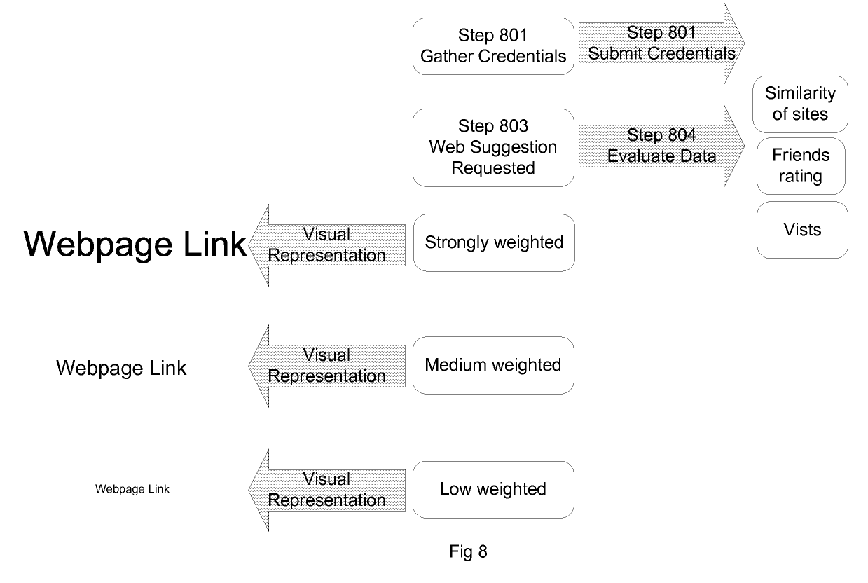

As shown in FIG. 8, the plugin can more prominently display websites who have a higher weight than other websites, making websites easier to find that are of likely more interest to the user. A webpage's display weight is determined by evaluating the similarity of websites rated by friends, the number of times users or friends have visited a similar website, and the number of friends who have rated a website highly. The proportion of each of these factors can be assigned different values to come up with an optimal arrangement. Webpages with a higher weight are displayed more prominently to the user than webpages with a lower rate. Webpages can be made more prominent by adding levels of bold to the webpage link, displaying the webpage link at the top of a list of recommended webpages, displaying the webpage link in various colors to add emphasis to highly weighted webpages, showing a screenshot of webpages with a high weight, adding a border around webpages with a high weight, displaying the weight value on or next to the webpage, or any other method or combination of methohds for adding emphasis to a webpage or link.

For example, User1 has rated webpage1 highly. Friend1 and Friend2 have rated webpage2 highly and have also rated webpage3 highly. Friend1 and Friend2 have visited webpage3 30 times but only visited webpage2 twice. Friend3 rated webpage1 low werbpage 2 high, and webpage3 low. Initially, Friend1, Friend2, and Friend3 all have the same weight (33%). Because Friend3 is not similar to Friend1, his weight is reduced by a certain percent (ex. Friend1 and Friend2 now have 40% each and Friend 3 has 20%). The three webpages are evaluated based on Friend1 and Friend2 and modified slightly for Friend3. Because Friend1 and Friend2 enjoy webpage3 and visit it often, webpage3 is the most prominently displayed website even though Friend3 did not rate webpage3 highly. Webpage2 is displayed less prominently than webpage3 but still more prominently than webpages shared by users not marked as a friend of the User1.

Alternatively, the user can also specify a greater weight for different friends. Friends with a greater weight can have their profile displayed at the top of the user's screen and will have their shared websites displayed more often to the user when the user is looking for new sites. For example, if User1 knows they have more in common with Friend1 than Friend3, they can set the plugin to recommend Friend1's shared webpages more often than Friend2's shared webpages.

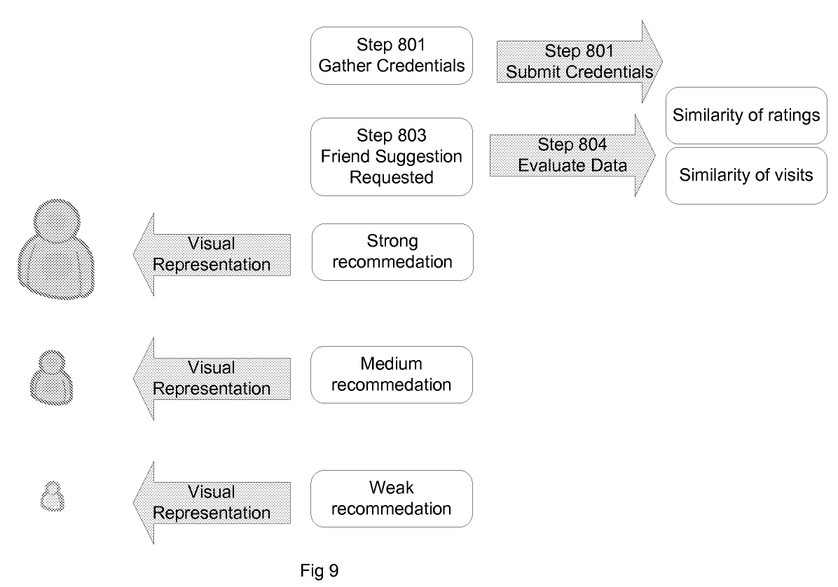

As shown in FIG. 9, the invention can also be used to help users find new friends. The plugin can determine and make friend recommendations based on any of the following similarities: webpages visited, number of friends in common, and webpage ratings, and geographic location. For example, if User1 has 1000 webpage visited that are similar to visits User2, but only 100 in common with User3 then User2 will be recommended as friend over User2. In an alternate example, if User1 and User2 have both rated webpage 1, webpage2, and webpage3 with five stars, and User3 has rated the same webpages with low stars, then User2 will be recommended as a friend to User1 over User3. The strength of the recommendation can be visualized by displaying the avatar or profile picture of the suggested friend in a highlighted or muted manner. This can be done by increasing the size of the avatar for strong recommendations and decreasing the size for weak recommendations. Alternatively, the profile picture of a strong suggestion can include a border or other flash colors to alert the user of a recommended friend. This has strong utility in the field of social networking as it allows users who are browsing other people's user profiles to find similar interests. The process can also be applied to social chat and dating sites.

Webpages presented to a user via the plugin should not be counted as webpages shared by the user in order to avoid creating inaccurate information. These sites are new sites being explored by the user and could be sites that user isn't really interested in. To fix this problem, either websites shared once by a user should be ignored as being random websites or the plugin should not share any webpages that are recommended by the plugin.

Revenue can be generated by selling advertising spots to merchants. The webpage of a merchant purchasing advertising is displayed on the list of popular websites as a “recommended” webpages. The merchant webpage can also be included in the list of webpages that are popular or that are shared by friends and can be displayed in a prominent manner. Alternatively, if the user is surfing the web, a merchant's webpage can be displayed every few webpages. The merchant's website can be highlighted in a different color to alert the user that it is a paid advertising spot.

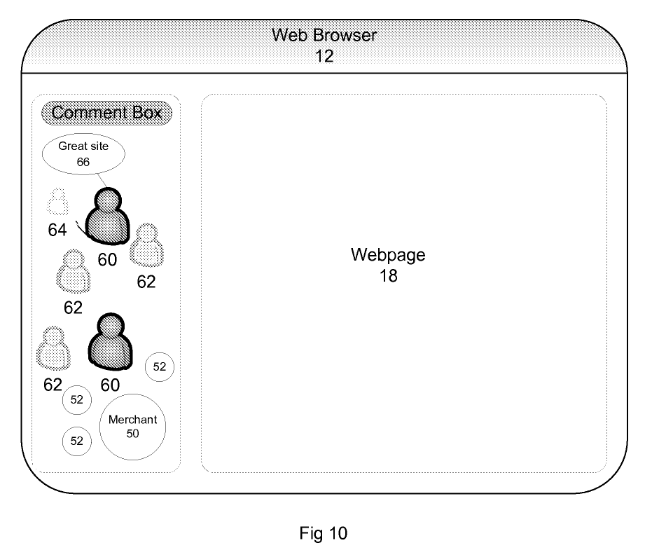

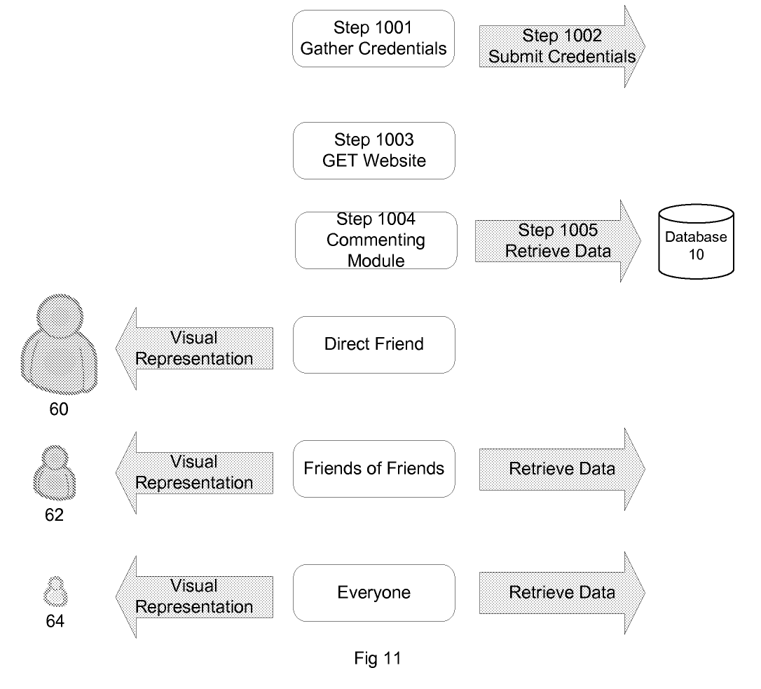

In an alternate embodiment shown in FIG. 10, a representation of the user's friends is displayed by the plugin while the user browses the internet. The representation is a name or by a graphical representation of the friend, such as by a profile picture or avatar. As the user browses various websites, comments 66 made by the friends 60 are retrieved and displayed to the user. The comments appear in a callout display, such as a speech or though bubble next to each friend's representation. The comments are either displayed automatically or displayed upon a certain user action occurring, such as the user moving the mouse over the friend's representation, clicking the representation of the friend, or clicking or moving the mouse anywhere else on the screen, browser, or webpage. Optionally, the friend's rating of the webpage is also displayed.

The actual friends of the user 60 are assigned the highest visual representation. This highest level of visual representation is big, bold, crisp images that could be actual pictures of friends. Data about each friend can optionally be retrieved to gather comments and ratings the friend has about the webpage. Once all the data is collected for this level of friends, it is assigned a visual representation level. Friends who have not visited the website or did not comment or rate the webpage can be grayed out or hidden from view.

The user can click the friend 60 to bring up their information or to see additional webpages liked by the friend. This works as above, where the plugin will retrieve information about the friend and display it next to the friend's representation.

Near each friend are smaller and less visible profiles. These profiles are the friend's of the friend displayed by the plugin (a second-tier friend) 62. A possible visual representation of these friends is where the images are duller, smaller, and less crisp than the previous level of friends. This can display the rating information of the second-tier friend, a pictorial representation of the second-tier friend, or the picture of the second-tier friend.

In an alternate embodiment, the image of the friends and second-tier friends is affected by the number of connections between the friend and the user. The more connections, the brighter and crisper the display of the image. This can be extended to other similarities, such as similar website visits, similar ratings, similar surfing habits, etc. Thus, if the friend has more in common with the user, their image or avatar will stand out more. Notice this bottom level is the smallest, dullest, least crisp image of all the friends.

This can continued to third-tier friends 64, fourth-tier friends, etc. Each level will be smaller and more faded that the higher tier until the last tier appears as dots on the viewing window. This can continue until the user hits the bottom level of friends which could include the entire user base of the system. Each of these levels could be displayed within a comment box as shown in FIG. 10.

Additionally the user could bring up the level of friends to a higher level of visual representation. This would involve the user clicking to promote the lower level of friends (such as the friends of friends 62) to be visually displayed as a higher level of friends. This would move all level's of friends up and out. The last one on the list will be removed from the visual representation. The levels of friends will have the ability to be restored to return to the original depiction of visual representation of friends and friends comments about the current website. As the user moves to a new website this entire process is performed again except the gather credentials.

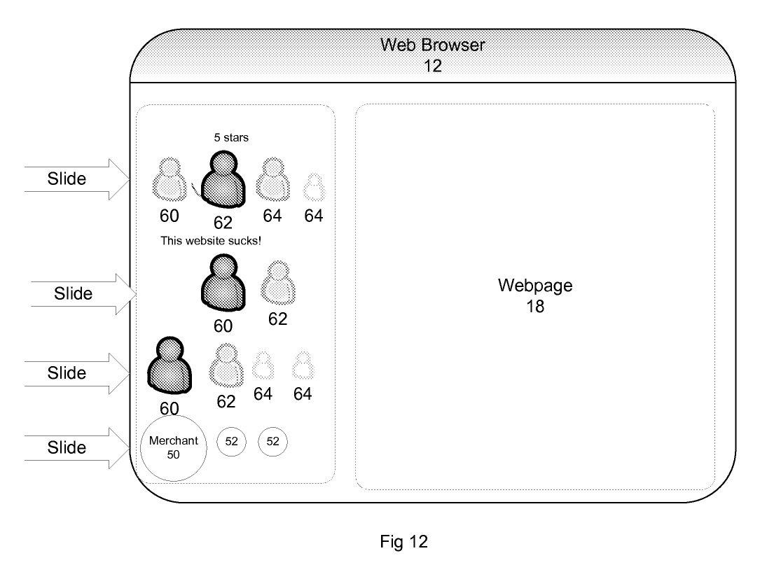

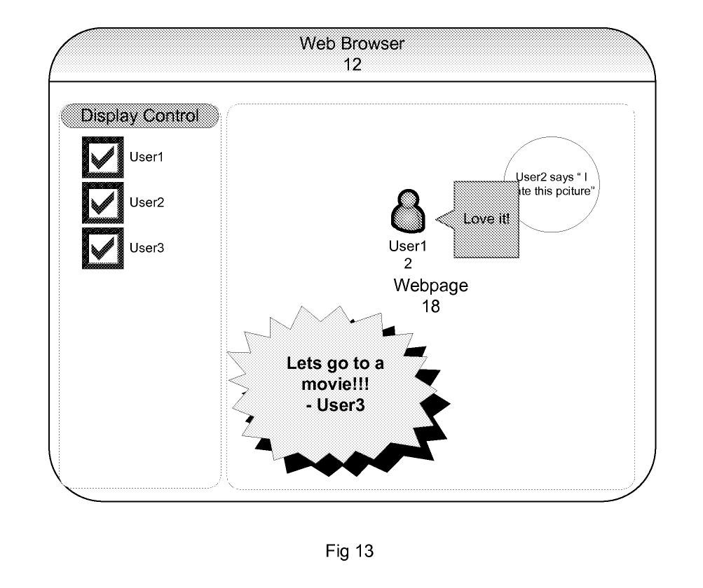

Alternatively, as shown in FIG. 12, the user can change friend levels by sliding or scrolling the level of friends. Sliding is popular and can be used on a smart phone to allow easy sliding between levels. As the level of friends changes, the new friend comes to the front of the scroll along with their comments and other information. The friend's profile or avatar whose information is displayed is highlighted in some fashion so the user knows who is making the comment. They can be displayed in a comment bar to the side of the webpage, a comment bar above, or by adding the comments directly to the webpage itself.

As an alternate embodiment as shown in FIG. 10, a merchant 50 can always be included as a friend as displayed by the plugin with other merchants displayed as the grayed out second-tier friends 52. This way the provider can collect higher fees from the prominently displayed merchant 50 and still collect fees for the second-tier merchants 52. The merchant can be displayed on a website that provides similar services. For example, a merchant providing an AntiVirus service can be displayed as a friend whenever a user browses to a website with a metatag that includes the word “antivirus”. Thus, the merchant is targeted towards their potential customers and the provider can sell multiple merchant subscriptions.

In another embodiment, users add comments in the form of notes directly to the webpage. These are selected from colors and styles that are available in the plugin, such as various balloon text or callout boxes. The user can drag and drop the note onto the webpage and add their comment or rating. The plugin stores the location where the note appears, either in relation to the browser or in relation to the website content. When a second user visits the site, they will see the note added by the first user. The note can include the user's name that added their note or their profile picture. Optionally, the user can limit notes to only those displayed by friends or only those added by certain users. Also optionally, notes can be set to expire after a certain time period so that they vanish from the webpage. As the note draws nearer to its expiration date, the note fades in color, becoming more and more transparent. Notes are set to always be on top, with the latest note overriding the display of earlier notes.

What is claimed is:

1. A method of displaying web pages comprising:
a) storing information about a visited webpage in a database; and
b) displaying the stored information to a computer user visiting the webpage.

2. A method according to claim 1, wherein the information is stored in the database automatically when the webpage is visited.

3. A method according to claim 1, where the information is selected from a group comprising: aggregate data about users visiting the webpage, the most frequently visited webpages, user opinion information about the webpage, the number of times a user visits a webpage, the total visits to the webpage, the length of visit to a webpage, a comment of a user, a rating of the webpage and a website identifier.

4. A method according to claim 1, further comprising only storing the information if the webpage content associated with the information meets set criteria.

5. A method according to claim 1, further comprising filtering the stored information displayed to the computer user based on criteria selected by the computer user.

6. A method according to claim 1, where the display of information occurs automatically when a webpage is loaded.

7. A method according to claim 1, further comprising only displaying the information if the user visiting the webpage is identified as a friend of the user who submitted the information stored in the database.

8. A method according to claim 1, wherein the display includes the number of times the a user has visited a webpage.

9. A method of sharing information comprising:
a. Having a first computer user visit a webpage,
b. Sharing information about the first computer user's actions related to the webpage with a second computer user.

10. A method according to claim 9 wherein the information comprises which webpages most frequently visited by the first computer user.

11. A method according to claim 9, wherein the sharing comprises showing the second computer user which webpage is currently being displayed to the first computer user.

12. A method according to claim 11, wherein the sharing of information comprises displaying the webpage being displayed in a popup window.

13. A method according to claim 9, wherein the sharing comprises sending a notification to the second computer when a selected action is taken by the first computer user.

14. A method according to claim 13, wherein the selected action is selected from a group comprising: the first computer user visiting a webpage, the first computer user rating a webpage, and the first computer user making a comment.

15. A method according to claim 9, wherein the sharing comprises redirecting the second computer user's browser to the webpage currently viewed by the first computer user.

16. A method according to claim 9, wherein the sharing of information comprises a chat interface.

17. A method according to claim 9, further comprising sharing aggregate information of several users.

18. A method according to claim 9, further comprising periodically updating the information shared with the second computer user.

19. A method according to claim 9, wherein the stored information is only shared after the first computer user has visited the webpage at least twice.

20. A method according to claim 9, further comprising sharing information of a merchant.

21. A method according to claim 9, wherein the merchant's profile is displayed prominently to the second computer user.

22. A method according to claim 9, wherein the sharing comprises displaying a representation of a user who shared the information.

23. A method according to claim 22, wherein the sharing further comprises displaying a comment by the user in a callout display.

24. A method according to claim 9, wherein the sharing comprises displaying a representation of the first computer user.

25. A method according to claim 24, wherein the representation changes depending on how the first computer user is associated with the second computer user.

26. A method according to claim 24, further comprising changing the representation after interaction by the second computer user.

27. A method according to claim 26, further comprising the second computer user changing the information displayed by scrolling through a set of users and having the information associated with a selected user displayed.

28. A method according to claim 26, further comprising the second computer user changing the information displayed by scrolling through a set of information.

29. A method according to claim 24, comprises varying the representation depending on the number of connections that the first computer user has in common with the second computer user.

30. A method according to claim 29, wherein the connections is selected from a group comprising: the similarity of the webpages visited by the first computer user and second computer user, the number of friends the first computer user has in common with the second computer user, and the similarity of the ratings given to webpages by the first computer user and second computer user.

31. A method according to claim 9, wherein the sharing comprises displaying the information as a note on a webpage.

32. A method according to claim 31, wherein the note includes a profile picture of the user who shared the information.

33. A method according to claim 31, wherein the note is always displayed in a location that is static relative to the content of the webpage.

34. A method according to claim 31, where the note's display fades over time.

35. A method according to claim 31, where the note is displayed only if the second computer user is a friend of the first computer user.

36. A method according to claim 31, where the note display is configurable by the first computer user.

37. A method according to claim 31, where the note display is configurable by the second computer user.

38. A method of sharing webpages, comprising:
a. Retrieving an identifier of a webpage from a database of identifiers submitted by users;
b. Displaying the webpage associated with identifier to a computer user.

39. A method according to claim 38, where a browser of the computer is automatically redirected to the webpage.

40. A method according to claim 38, where at least one user is a merchant.

41. A method according to claim 38, where the retrieved identifier is determined by set criteria.

42. A method according to claim 41, where the set criteria is selected from a group comprising: the webpages previously visited by the computer user, the webpage ratings submitted to the database by the computer user, the similarity of the webpage associated with the identifier to webpages visited by the computer user's friends.

43. A method according to claim 38, where the identifier is displayed to the computer user and the webpage is displayed after the computer user clicks the identifier.

44. A method according to claim 43, where the identifier's display changes depending on the number of friends of the computer user that have visited the webpage associated with the identifier.

45. A method according to claim 43, where the identifier is displayed more prominently if the webpage is recommended to the computer user and the identifier is displayed less prominently if the webpage is not recommended to the computer user.

46. A method of finding friends, comprising:
a. comparing webpage information submitted to a database by a first user to webpage information submitted by other users; and
b. displaying a representation of a second user to the first user where the representation of the second user depends on a calculated compatibility between the first user and second user.
